(19) United States
(12) Patent Application Publication
(10) Pub. No.: US 2007/0223024 A1
(43) Pub. Date: Sep. 27, 2007

(54) Computer-readable recording medium storing program for setting function in printer driver, method of setting the same, and print request device

(75) Inventor: Yoshikazu Takesada, Itami-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/490,202

(22) Filed: Jul. 21, 2006

(30) Foreign Application Priority Data
Mar. 23, 2006 (JP) 2006-080327

(51) Int. Cl. G06F 3/12

(52) U.S. Cl. 358/1.13

(57) ABSTRACT

In a device requesting a printing process of a printer, when information relating a printer driver with a setting for a function concerning a printing operation is input, the setting is stored in a storage region for storing a setting of a function concerning a printing process for the printer driver. The information relating the printer driver with the setting is related to at least one of an icon corresponding to the printer driver and an icon corresponding to the setting.

This application is based on Japanese Patent Application No. 2006-080327 filed with the Japan Patent Office on Mar. 23, 2006, the entire content of which is hereby incorporated by reference.

### BACKGROUND OF THE INVENTION

1. Field of the Invention

The present invention relates to setting of a printer driver, and more particularly to a computer-readable recording medium storing a program for setting a function in a printer driver, and a method of setting the same, and a device making a print processing request.

2. Description of the Related Art

When a document or image created by a personal computer is printed on a copying paper, a printer is connected to the personal computer and is controlled by the personal computer for printing. In such a case, a printer driver for controlling the printer connected to the personal computer needs to be installed in the personal computer.

A personal computer allows a function of a printer to be set for a printer driver. For example, Japanese Laid-Open Patent Publication No. 2005-202493 discloses a technique for setting a port used by a printer driver and a function of a printer.

To set a function of a printer, users need to perform a setting operation, such as selecting a radio button, for each function. Here, even if there are a plurality of functions to be set, users need to perform a setting operation for each function. Therefore, users may sometimes feel such an operation cumbersome.

### SUMMARY OF THE INVENTION

The present invention is made in view of the aforementioned situation. An object of the present invention is to facilitate an operation for setting a function in a printer driver in a device that makes a print request.

A computer-readable recording medium in accordance with one aspect of the present invention stores a program executed in a device requesting a printing process of a prescribed printer for setting a function in a printer driver. The stored program causes the device to perform: an icon display step of displaying an icon of at least one of the printer driver and a setting for a function concerning a printing operation stored beforehand; an input step of externally receiving an input of information; and a storing step of storing the setting into a storage region for storing a setting of a function in the printer driver when information relating the printer driver with the setting is received at the input step. The information relating the printer driver with the setting is an input information related to one of a first icon that is an icon corresponding to the printer driver and a second icon that is an icon corresponding to the setting.

A printer driver setting method in accordance with another aspect of the present invention makes setting of a function in a printer driver executed in a print request device requesting a printing process of a prescribed printer. The method includes: an icon display step of displaying an icon of at least one of the printer driver and a setting for a function concerning a printing operation stored beforehand; an input step of externally receiving an input of information; and a storing step of storing the setting in a storage region for storing a setting of a function in the printer driver when information relating the printer driver with the setting stored is received at the input step. The information relating the printer driver with the setting is an input information related to at least one of a first icon that is an icon corresponding to the printer driver and a second icon that is an icon corresponding to the setting.

A print request device in accordance with still another aspect of the present invention requests a printing process of a prescribed printer. The device includes: a first storage part storing a setting for a function concerning a printing process; a second storage part storing a setting for a function concerning a printing process for a printer driver; an icon display displaying an icon of at least one of the printer driver and the setting stored in the first storage part; an input unit externally receiving an input of information; and a controller storing the setting stored in the first storage part into the second storage part when the input unit receives information relating the printer driver with the setting stored in the first storage part. The information relating the printer driver with the setting stored in the first storage part is an input information related to at least one of a first icon corresponding to the printer driver and a second icon that is an icon corresponding to the setting stored in the first storage part.

In accordance with the above mentioned features, when making a setting of a function in a printer driver, the user makes an input related to either a driver icon or a settings icon, so that the settings for the function concerning a printing process that are stored beforehand can be stored in a print request device as the settings for the function concerning a printing process for a printer driver.

Therefore, the user can make a setting for a function concerning a printing process for a printer driver with an input operation related to an icon. Accordingly, the above mentioned features facilitate an operation for setting a function in a printer driver. It is noted that even if a plurality of setting items exist for a function concerning a printing process, the settings thereof are stored beforehand so that the user can store those settings in a print request device as the settings of a function in a printer driver, with an input operation related to an icon.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a configuration of a printer system including a terminal device that is an exemplary print request device in accordance with one embodiment of the present invention.

FIG. 2 is a diagram showing a hardware configuration of the terminal device in FIG. 1.

FIG. 3 is a control block diagram of a part that makes a settings for printing contents in an environment file in the terminal device in FIG. 1.

FIG. 4 shows a window appearing on a display in FIG. 2 in connection with a folder in which a printer driver is stored in a hard disk.

FIG. 5 is a flowchart of a process performed by a CPU (Central Processing Unit) in FIG. 2 when the window shown in FIG. 4 appears.

FIG. 6 is a flowchart of a process performed to store the settings included in a setting file into the environment file when an application is executed in the terminal device in FIG. 1.

FIG. 7 shows an exemplary print window appearing on the display in FIG. 2.

FIG. 8 is a flowchart of a subroutine of a DD operation process in FIG. 6.

FIG. 9 shows an exemplary preview window appearing on the display in FIG. 2.

FIG. 10 shows an exemplary window showing the settings appearing on the display in FIG. 2.

FIG. 11 is a flowchart of a subroutine for a right-click operation in FIG. 6.

FIG. 12 shows an exemplary setting window appearing on the display in FIG. 2.

### DESCRIPTION OF THE PREFERRED EMBODIMENTS

In the following, an embodiment of the present invention will be described with reference to the figures. It is noted that in the following description, the same components will be denoted with the same reference characters, except for particular cases, and the description will not be repeated.

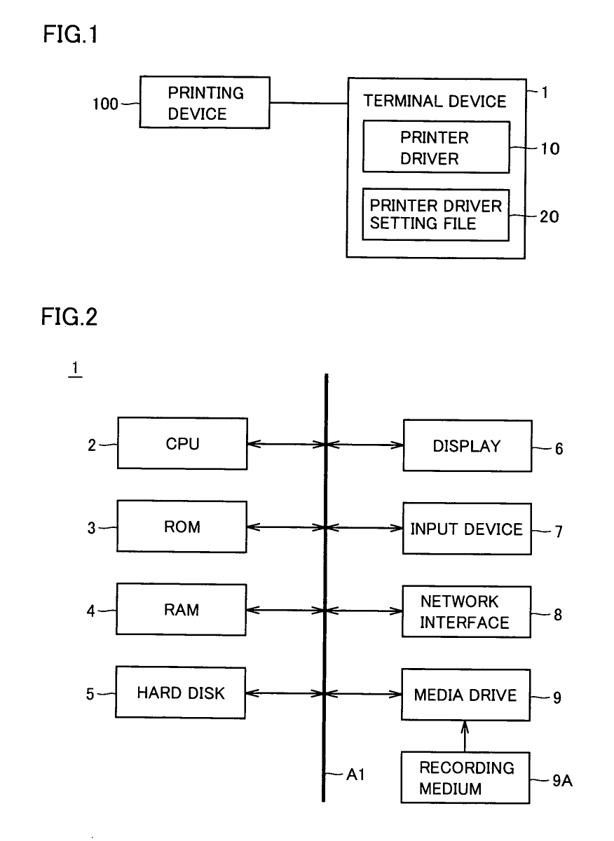

Referring to FIG. 1, in a printer system, a terminal device 1 includes, for example, a general-purpose personal computer, and a printing device 100 includes, for example, MFP (Multi Function Peripheral). It is noted that terminal device 1 and printing device 100 are not limited thereto and may be any device as long as they have the equivalent functions within the range of the description in the present embodiment.

Furthermore, in the printer system in FIG. 1, a print request device and a printer are connected to each other. However, the number of the devices included in the system may not limited thereto. In addition, the connection between the devices may be either wired or wireless. These devices may be connected directly or connected via a network. In the present embodiment, terminal device 1 and printer 100 are connected to each other via a not-shown network.

Terminal device 1 issues a print request to printing device 100. Terminal device 1 has installed therein a printer driver 10 for controlling printing device 100 and, in addition, stores a printer driver setting file 20 including the settings for printer driver 10. It is noted that terminal device 1 stores a plurality of printer driver setting files, as described later, including the settings for a printing process of printing device 100, in addition to printer driver setting file 20 as an environment file of printer driver 10. In the present embodiment, printer driver setting file 20 as an environment file of printer driver 10 is simply referred to as “an environment file” as necessary, as distinguished from a plurality of printer driver setting files as described above.

FIG. 2 shows a hardware configuration of terminal device 1.

Terminal device 1 includes a CPU 2 controlling the entire terminal device 1, an ROM (Read Only Memory) 3 storing programs or constants, an RAM (Random Access Memory) 4 temporarily storing data, a hard disk 5 for storing a program executed by CPU 2 and a variety of settings, a display 6 displaying information according to an instruction from CPU 2, an input device 7 receiving an operation from the user, a network interface 8 controlling communications with other equipment via a network, and a media drive 9 reading and writing information from/to a recording medium 9A removable from terminal device 1, such as a CD-ROM (Compact Disc Read Only Memory). Input device 7 includes a pointing device such as a mouse. In terminal device 1, each component is connected to a bus A1 and those components are connected to each other via bus A1.

In terminal device 1, the program and printer driver setting file 20 (environment file) that configure printer driver 10 are stored, for example, in hard disk 5.

Furthermore, in terminal device 1, a variety of information about printer driver 10 is stored in hard disk 5. Such information includes, for example, information about a connection port used for printer driver 10. The information about a connection port may include a connection port used for printer driver 10, the designation of the connection port, an IP (Internet Protocol) address of printing device 100, and function specifying information of about a few bytes. Terminal device 1 may define the IP address of printing device 100 and the designation of the connection port based on information input from input device 7. The function specifying information has each bit assigned to each function for a printing process of printing device 100 to specify whether or not the function is included based on the value of each bit. For example, if “1 point staple” function is assigned to the first bit, “2 Copy” function is assigned to the second bit, and “2 point staple” function is assigned to the third bit, and if the function specifying information includes the first bit having a value of “1”, the second bit having a value of “1”, and the third bit having a value of “0”, then printing device 100 includes “1 point staple” function and “2 Copy” function but does not include “2 point staple” function. It is noted that the function of printing device 100 will be described later with reference to FIG. 4.

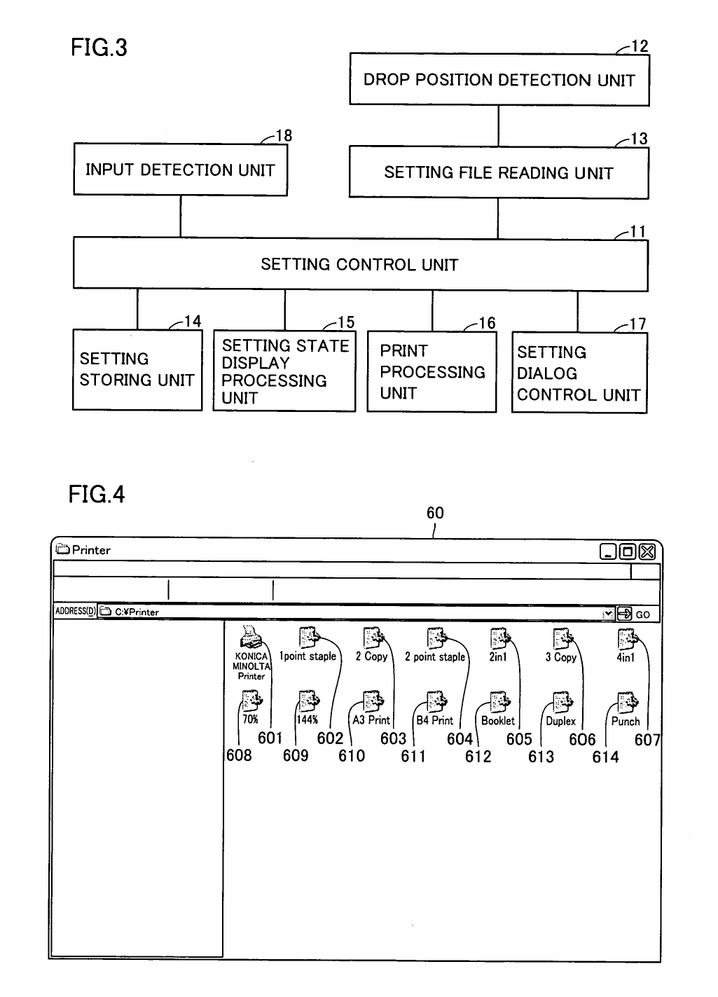

FIG. 3 is a control block diagram of a part that makes a setting for printing contents in the environment file in terminal device 1. FIG. 4 shows a window appearing on display 6 in connection with a folder in which printer driver 10 is stored in hard disk 5.

A window 60 of FIG. 4 contains a printer icon 601 corresponding to printer driver 10 and setting file icons 602-614 respectively corresponding to a plurality of printer driver setting files stored in hard disk 5. It is noted that in the present embodiment, a driver icon displayed corresponding to the printer driver is formed of printer icon 601.

It is noted that setting file icon 602 corresponds to a file concerning a function of stapling copy paper at one point after print processing. Setting file icon 603 corresponds to a file concerning a function of making two copies in one-time print processing. Setting file icon 604 corresponds to a file concerning a function of stapling copy paper at two points after print processing. Setting file icon 605 corresponds to a file concerning a function of copying two sheets of originals to be arranged and reduced in one sheet of copy paper. Setting file icon 606 corresponds to a file concerning a function of making three copies in one-time print processing. Setting file icon 607 corresponds to a file concerning a function of copying four sheets of originals to be arranged and reduced in one sheet of copy paper. Setting file icon 608 corresponds to a file concerning a function of setting a copy magnification to 70%. Setting file icon 609 corresponds to a file concerning a function of setting a copy magnification to 144%. Setting file icon 610 corresponds to a file concerning a process of selecting an A3 sheet as copy paper. Setting file icon 611 corresponds to a file concerning a process of selecting a B4 sheet as copy paper. Setting file icon 612 corresponds to a file concerning a function of finishing a plurality of originals in a double-sided saddle-stitched copy. Setting file icon 613 corresponds to a file concerning a function of double-sided printing. Then, setting file icon 614 corresponds to a file concerning a function of punching a hole in copy paper after print processing.

Referring to FIG. 3, terminal device 1 includes a drop position detection unit 12 detecting a position of a drop when the pointing device of input device 7 is used to drag and drop an icon among setting file icons 602-614, a setting file reading unit 13 reading the settings stored in the printer driver setting file corresponding to the dropped icon, a setting storing unit 14 storing the settings in the environment file described above, a setting state display processing unit 15 causing the setting state of the environment file or a plurality of printer driver setting files to appear on display 6, a print processing unit 16 performing a process of requesting a printing process of printing device 100, a setting dialog control unit 17 causing a dialog to appear on display 6 as appropriate when the settings are stored in the environment file, and an input detection unit 18 detecting the details of an input to input device 7, other than the one detected by drop position detection unit 12. Each component shown in FIG. 3 is realized by CPU 2 executing a program as appropriate.

Now, referring to FIG. 5, a process performed by CPU 2 to store (or update) the settings in the environment file when window 60 shown in FIG. 4 is displayed.

First, at step SA10, CPU 2 determines whether or not an input is made to drag and drop (abbreviated as “DD” in FIG. 5) any of setting file icons 602-614 onto printer icon 601. Then, if it is determined that such an input is made, the process proceeds to step SA20.

At step SA20, CPU 2 determines, for the setting file that corresponds to the icon receiving the input at step SA10 among the setting file icons 602-614, whether or not the settings included in that file are valid for printer driver 10. If they are determined as valid, the process proceeds to step SA30, and if they are determined as invalid, the process proceeds to step SA40.

It is noted that at step SA20, CPU 2 compares the function included in the settings in the setting file with the function specifying information as described above. If all the functions included in the settings in the setting file are included based on the function specifying information, CPU 2 determines that the setting file is valid. If even one function included in the settings in the setting file is not included based on the function specifying information, CPU 2 determines that the setting file is invalid.

At step SA30, CPU 2 stores the settings included in the setting file in the environment file and returns the process to step SA10. It is noted that if the settings for a function included in a setting file are included in the environment file, CPU 2 overwrites the settings for the function on those of the setting file for updating.

On the other hand, at step SA40, CPU 2 causes a message to appear on display 6 that gives notification that the function having the settings included in the setting file is invalid in printing device 100, such that “the function included in this setting file is invalid in this printer”. Then, the process returns to step SA10.

It is noted that here, the process proceeds to step SA20 on the condition that it is detected that setting file icons 602-614 are dropped on printer icon 601 at step SA10. At this point, CPU 2 determines that setting file icons 602-614 are dropped on printer icon 601 if they are at least partially dropped on a position where they overlap with at least a part of printer icon 601.

In addition, in the process described with reference to FIG. 5 above, when any of setting file icons 602-614 is dropped onto printer icon 601, the settings in the file corresponding to the dropped icon are stored in the environment file. It is noted that the settings in the setting file may be updated to be stored in the environment file by an operation other than a drag-and-drop.

For example, when any of setting file icons 602-614 receives an input by a right click using the pointing device, CPU 2 displays a menu or dialog that asks whether to store the settings in the environment file, in connection with the icon receiving the input, and then stores the settings included in the above-noted setting file into the environment file, similarly to step SA30, on the condition that an input is made to confirm that the settings are to be stored in the environment file.

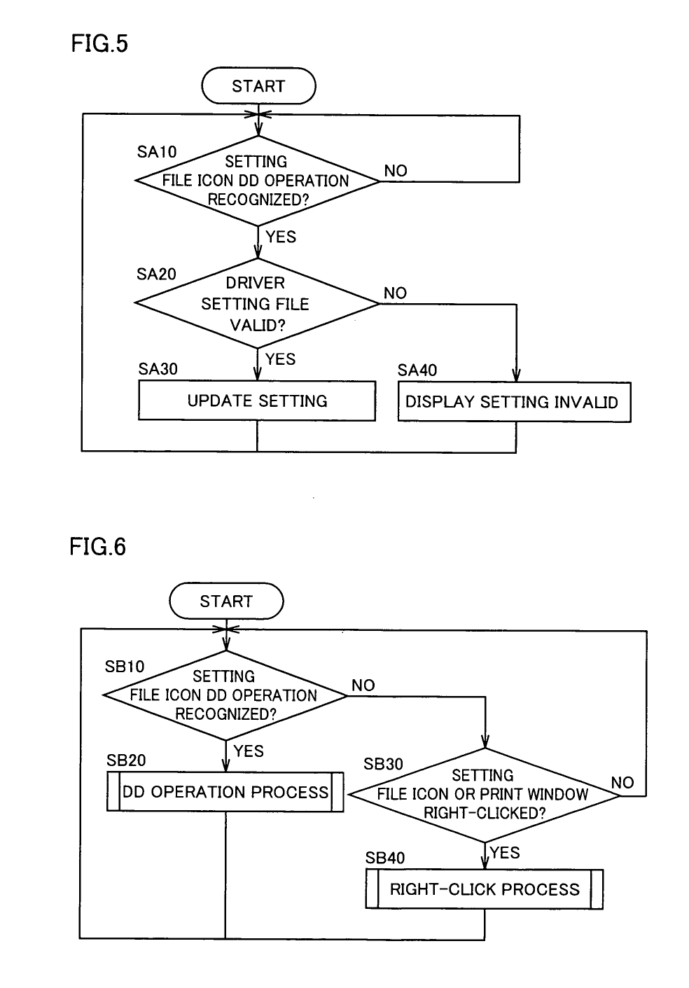

It is noted that terminal device 1 in this embodiment can store the settings included in the setting file into the environment file even when any application such as an application having a word-processor function is executed in terminal device 1. In the following, such a process will be described with reference to FIG. 6.

At step SB10, CPU 2 first determines whether or not an input is made on input device 7 to drag and drop any of setting file icons 602-614. Then, if it is determined that such an input is made, the process proceeds to step SB20, and if it is determined that such an input is not made, the process proceeds to step SB30.

At step SB20, CPU 2 returns the process to step SB20 after performing a DD operation process. The DD operation process will be described later.

On the other hand, at step SB30, CPU 2 determines whether or not a right-clicking input is made on the pointing device while the pointing device is positioned on any of setting file icons 602-614 or on a print window. If it is determined that such an input is made, the process proceeds to step SB40. If it is determined that such an input is not made, the process returns to step SB10 as it is.

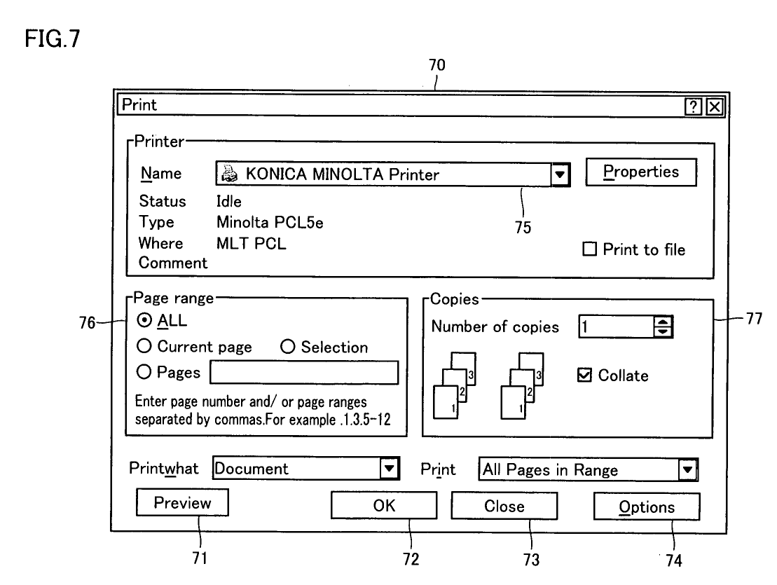

An exemplary print window appearing on display 6 is shown in FIG. 7. A print window 70 is a window appearing when an input is made to request printing on an application. Print window 70 contains a display field 75 to display the designation of printing device 100, a preview button 71, an OK button 72, a Close button 73, and an option button 74. When information of plurality of printing devices is registered in terminal device 1, the designations of a plurality of printing devices may be displayed as a pull-down menu in display field 75. In addition, print window 70 contains a setting region 76 for inputting information to set a print range of an application file and a setting region 77 for inputting information to set a number of copies.

Upon reception of an input to select the designation of a printing device from the displayed designations of a plurality of printing devices, CPU 2 sets the selected printing device as a destination of print data. Preview button 71 is a button for previewing a printing manner based on the settings in the printer driver at that time. OK button 72 is a button for requesting printing by transmitting print data to printing device 100. Close button 73 is a button for stopping a setting operation for print processing. Option button 74 is a button for displaying the settings other than those displayed in print window 70.

It is noted that CPU 2 can display print window 70 and window 60 (see FIG. 4) at the same time on display 6.

Referring to FIG. 6 again, at step SB40, CPU 2 returns the process to step SB10 after performing the right-click process. It is noted that the right-click process will be described later.

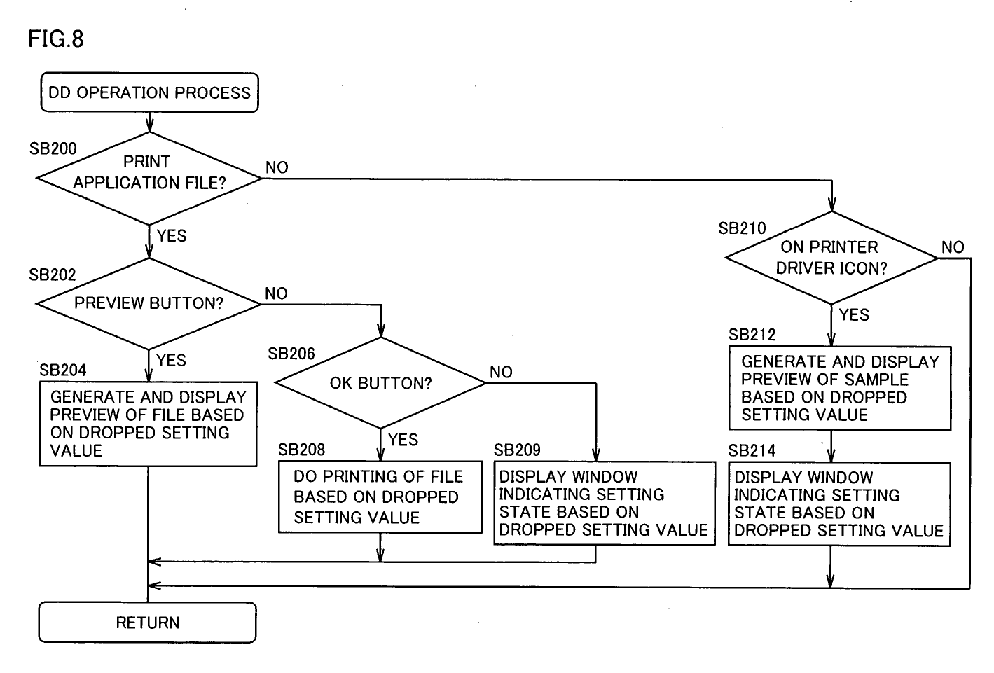

In the following, referring to FIG. 8, the DD operation process at step SB20 will be described.

At step SB200, CPU 2 determines whether or not a file is opened for an application under execution and a request for printing of the file is maintained, that is, whether or not the print window as shown in FIG. 7 is displayed. Then, if CPU 2 determines that the request for printing is maintained, the process proceeds to step SB202. If CPU 2 determines that the request for printing is not maintained, the process proceeds to step SB210. It is noted that the request for printing is submitted to printing device 100 by operating OK button 72, or the ongoing request for printing is cancelled by operating Close button 73.

At step SB202, it is determined whether or not the setting file icon is dropped on preview button 71, and if so, the process proceeds to step SB204. If not, the process proceeds to step SB206.

At step SB204, CPU 2 stores (updates) the settings in the setting file corresponding to the dropped icon into the environment file and then displays an image of the printing result of the opened file with application of the stored or updated settings. Then, the process returns to FIG. 6.

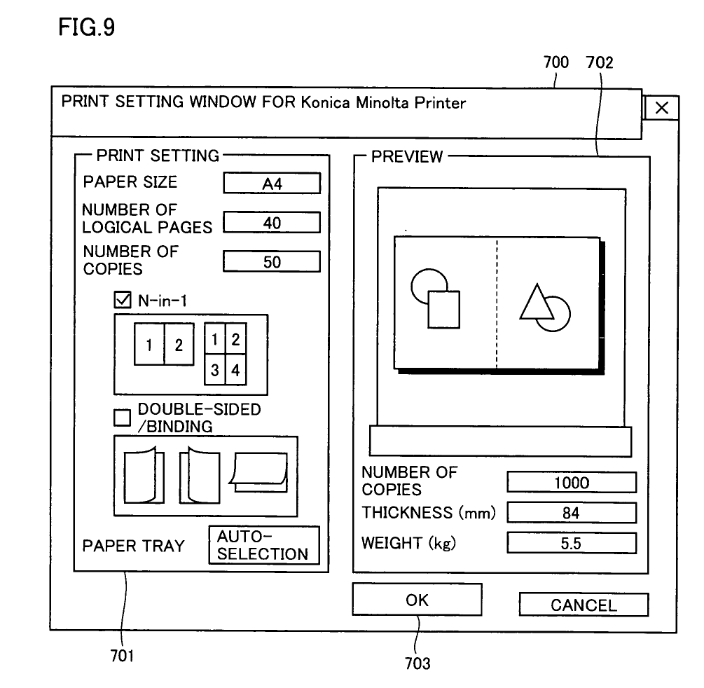

FIG. 9 shows an exemplary preview window appearing on display 6 through the process at step SB204.

Referring to FIG. 9, a preview window 700 contains a print setting field 701 showing the settings of the printer driver and a preview field 702 displaying an image of a printing result. It is noted that preview field 702 displays an image of a printing result that incorporates the settings such as use of 2-in-1 function (a function of copying two sheets of originals to be reduced and arranged in one sheet of copy paper). That is, FIG. 9 shows a preview window 700 when the setting file icon 605 shown in FIG. 4 is dragged and dropped on the preview button 71.

Referring to FIG. 8 again, at step SB206, CPU 2 determines whether or not the setting file is dropped onto OK button 72, and if so, the process proceeds to step SB208. If not, the process proceeds to step SB209.

At step SB208, CPU 2 stores (updates) the settings in the setting file corresponding to the dropped icon into the environment file and then makes a print request to printing device 100 with application of the stored or updated settings. Thus, printing of the file is done in printing device 100. CPU 2 returns the process to FIG. 6 after performing the process at step SB208.

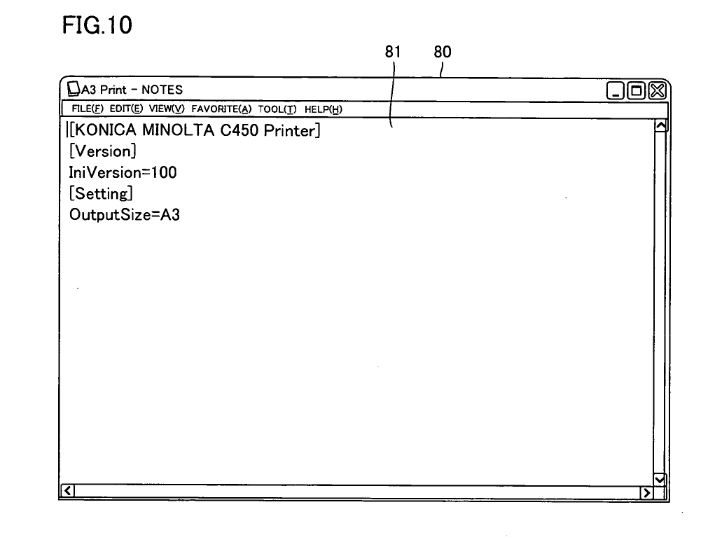

At step SB209, CPU 2 stores (updates) the settings in the setting file corresponding to the dropped icon into the environment file and then displays the stored or updated settings on display 6. Then, the process returns to FIG. 6. FIG. 10 shows an exemplary window that displays the settings.

Referring to FIG. 10, in a window 80, the settings for a printing process are shown in a settings display field 81. It is noted that the settings display field 81 includes the first line indicating the designation of a printer, the second to third lines indicating the version information of a printer driver, and the fourth to fifth lines indicating information about the function as being set. Specifically, it is displayed that a setting value “A3” is set for a function of defining an output size.

It is noted that FIG. 10 shows a window that appears when a setting file icon 610 shown in FIG. 4 is dropped onto a position other than preview button 71 and OK button 72 within the print window 70. In other words, terminal device 1 displays the window as shown in FIG. 10 in response to a prescribed input on a setting file icon such as a drop at a position other than preview button 71 and OK button 72. It is noted that when information for changing text information is input on the window shown in FIG. 10, the contents of the setting file corresponding to the target setting file icon are also updated. The window showing the settings as shown in FIG. 10 may be displayed when a prescribed input such as a right-click is made on print window 70 in order to display the settings stored in the environment file at that point. In the window displayed when a prescribed input is made on print window 70, the settings stored in the environment file are defined.

Referring to FIG. 8 again, at step SB210, CPU 2 determines whether or not the setting file icon is dropped onto printer icon 601, and if so, the process proceeds to step SB212. If not, the process returns to FIG. 6.

At step SB212, CPU 2 stores (updates) the settings in the setting file corresponding to the dropped icon into the environment file and then displays an image of a printing result for a sample file with application of the stored or updated settings. Then, the process proceeds to step SB214. The image of printing result for a sample file as displayed here is an image as displayed in preview field 702 of FIG. 9 for the sample file having a display object stored beforehand in hard disk 5 or the like.

At step SB214, CPU 2 causes the stored or updated settings to appear on display 6, for example, as shown in FIG. 10, and then returns the process to FIG. 6.

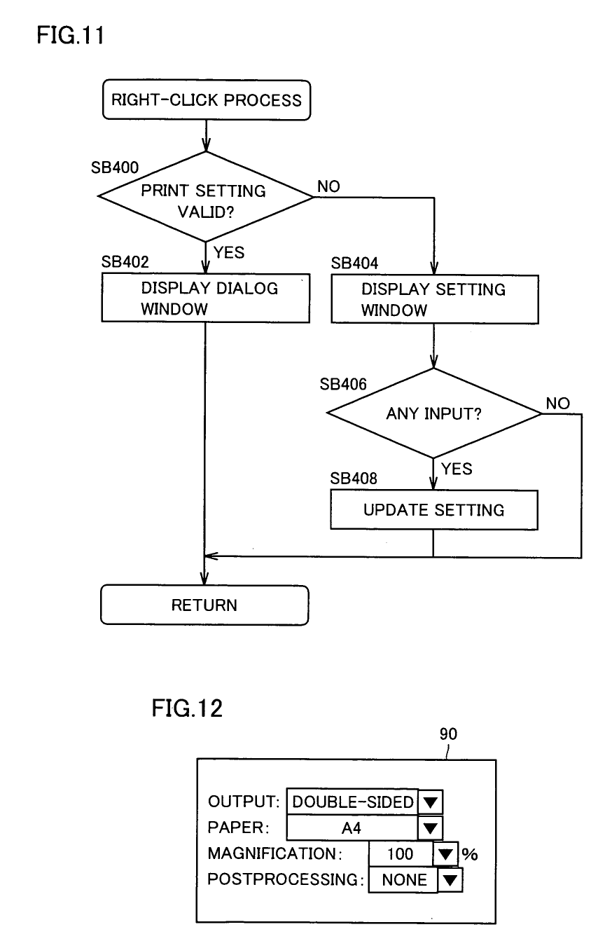

Now, referring to FIG. 11, the right-click process at step SB40 in FIG. 6 will be described.

In the right-click process, first, at step SB400, CPU 2 determines whether or not the settings included in the setting file corresponding to the right-clicked icon are valid for printer driver 10, similarly to step SA20. If they are determined as valid, the process proceeds to step SB402, and if they are determined as invalid, the process proceeds to step SB404.

At step SB402, a dialog window is displayed to store the settings included in the setting file corresponding to the right-clicked icon into the environment file. This dialog window may be, for example, preview window 700 shown in FIG. 9. At step SB402, preview window 700 is displayed based on the settings in the setting file corresponding to the right-clicked icon. It is noted that when an input is made on OK button 703 in preview window 700, the settings in the setting file are stored in the environment file on the condition as such.

At step SB404, CPU 2 causes a setting window for inputting the settings to be stored in the environment file to appear on display 6. FIG. 12 shows an exemplary setting window as displayed here.

Referring to FIG. 12, in a setting window 90, the settings are displayed as for either double-sided or single-side output, the size of output paper in printing, a printing magnification, and post-processing such as stapling. It is noted that these settings can be input by choosing from predetermined items in a pull-down menu.

Then, at step SB406, CPU 2 determines whether or not an input of the settings is made on setting window 90, and if so, at step SB408, the contents stored in the environment file (the settings of the printer driver) are updated by storing the input settings in the environment file. Then, the process returns to FIG. 6.

In the DD operation process described above with reference to FIG. 8, the position where the icon is dropped is detected at steps SB202 and SB206, and then a different process is performed depending on the detected position at steps SB204, 208, 209. It is noted that the process performed after changing the settings of the printer driver is in connection with the detected position (preview button 71, OK button 72). In other words, a drag onto preview button 71 causes a preview window to appear (step SB204), and a drag onto OK button 72 causes printing to be done. This facilitates a change (setting) of the settings of the printer driver and in addition, provides a user with service (for example, presentation of information) resulting from the input made by the user.

In addition, in accordance with this embodiment, by dropping a setting file icon onto preview button 71 when print window 70 is displayed with a file (application file) opened in an application, the user can preview the printing result of the application file according to the settings corresponding to the dragged setting file icon, through the process at step SB204. It is noted that in this embodiment, as shown in FIG. 4, a plurality of setting file icons having settings different from one another are displayed.

Accordingly, when the user drops setting file icon 602 onto preview button 71, through the process at step SB204, preview field 702 displays the printing result according to the setting corresponding to setting file icon 602, that is, the printing result giving an image of the state of being stapled at one point. In this state, when the user additionally drops setting file icon 605 onto preview button 71, through the process at step SB204, preview field 702 displays the printing result additionally corresponding to the setting corresponding to setting file icon 605, that is, the printing result giving an image of the state of being stapled at one point and also being copied by arranging and reducing two sheets of originals in one sheet of copy paper.

In other words, when a plurality of setting file icons having settings different from one another are displayed, the user can preview the printing result having the combined settings corresponding to a plurality of setting file icons, as described above.

Furthermore, in the present embodiment, a setting file corresponding to each of setting file icons 602-614 is preferably stored in the same folder with printer driver 10. The setting file described above may be installed in terminal device 1 concurrently with installation of printer driver 10 or may be installed in terminal device 1 after or before installation of printer driver 10.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A computer-readable recording medium storing a program executed in a device requesting a printing process of a prescribed printer for setting a function in a printer driver, said program causing said device to perform:
an icon display step of displaying an icon of at least one of said printer driver and a printer setting for a function concerning a printing operation;
an input step of externally receiving an input of information; and
a storing step of storing the printer setting into a storage region for storing a setting of a function in said printer driver when information relating said printer driver with the printer setting is received at said input step, wherein
said information relating said printer driver with the setting is an input information related to one of a first icon that is an icon corresponding to said printer driver and a second icon that is an icon corresponding to the printer setting.

2. The computer-readable recording medium according to claim 1, wherein
said icon display step displays both of said first icon and said second icon, and
said information relating said printer driver with the printer setting is information of said second icon being selected, dragged and then dropped on said first icon.

3. The computer-readable recording medium according to claim 2, wherein said program for setting further causes said device to perform:
a setting determination step of determining whether the printer setting is valid or invalid for said printer driver when information selecting said second icon is received at said input step; and
a notification step of giving notification that it is determined as invalid at said setting determination step.

4. The computer-readable recording medium according to claim 3, wherein function information indicating presence or absence of each function for at least one function for said printer driver is stored in the device in advance, and
said setting determination step determines whether the printer setting is valid or invalid for said printer driver by comparing said information selecting said second icon with said function information.

5. The computer-readable recording medium according to claim 4, wherein said function information is stored in the device in relation to port information specifying a connection port used for said printer driver.

6. The computer-readable recording medium according to claim 5, wherein said function information and said port information are stored in the device as port related information including designation information specifying a designation of the connection port which is specified by said port information,
and wherein said setting determination step determines whether the printer setting is valid or invalid for said printer driver by comparing said information selecting said second icon with said function information included in said port related information.

7. The computer-readable recording medium according to claim 2, wherein said program for setting further causes said device to perform the steps of:
detecting whether or not prescribed information concerning said second icon is input; and
upon detection that said prescribed information is input, displaying the setting stored in the storage region for storing a setting of a function in said printer driver at said storing step, and receiving a change of the setting.

8. The computer-readable recording medium according to claim 1, wherein
said icon display step displays at least said second icon, and
said information relating said printer driver with the printer setting is information of said second icon being selected, dragged and then dropped onto a print window displayed when a request for a printing process is received during execution of an application.

9. The computer-readable recording medium according to claim 8, wherein said program for setting further causes said device to perform:
a position detection step of detecting a position at which said second icon is dropped when information of said second icon being dropped onto said print window is received at said input step; and
a specific process performing step of performing a specific process that is based on the printer setting and depends on a position detected at said position detection step.

10. The computer-readable recording medium according to claim 9, wherein said program for setting further causes said device to perform a file determination step of determining whether or not an application file corresponding to said application is opened when said information of said second icon being dropped onto said print window is received at said input step, and
said specific process performing step performs, as said specific process, a process of displaying a print preview window based on the printer setting for said application file, when it is detected at said position detection step that said second icon is dropped at a prescribed position and when it is determined at said file determination step that said application file is opened.

11. The computer-readable recording medium according to claim 10, wherein said specific process step performs, as said specific process, a process of displaying a print preview window based on the printer setting for a sample file, when it is determined at said position detection step that said second icon is dropped onto said prescribed position and when it is determined at said file determination step that said application file is not opened.

12. The computer-readable recording medium according to claim 10, wherein said specific process step performs, as said specific process, a process of requesting of said prescribed printer a printing process based on the printer setting for said application file, when it is detected at said position detection step that said second icon is dropped at a specific position different from said prescribed position and when it is determined at said file determination step that said application file is opened.

13. The computer-readable recording medium according to claim 8, wherein said program for setting further causes said device to perform the steps of
detecting whether or not a prescribed input is made on said print window; and
upon detection that said prescribed input is made, displaying the setting stored in the storage region for storing a setting for a function in said printer driver at said storing step, and receiving a change of the setting.

14. A printer driver setting method of making a setting of a function in a printer driver executed in a print request device requesting a printing process of a prescribed printer, the method comprising:
an icon display step of displaying an icon of at least one of said printer driver and a printer setting for a function concerning a printing operation;
an input step of externally receiving an input of information; and
a storing step of storing the printer setting in a storage region for storing a setting of a function in said printer driver when information relating said printer driver with the printer setting is received at said input step, wherein
said information relating said printer driver with the printer setting is an input information related to at least one of a first icon that is an icon corresponding to said printer driver and a second icon that is an icon corresponding to the printer setting.

15. A print request device requesting a printing process of a prescribed printer, comprising:
a first storage part storing a setting for a function concerning a printing process;
a second storage part storing a setting for a function concerning a printing process for a printer driver;
an icon display unit displaying an icon of at least one of said printer driver and the setting stored in said first storage part;
an input unit externally receiving an input of information; and
a controller storing the setting stored in said first storage part into said second storage part when said input unit receives information relating said printer driver with the setting stored in said first storage part, wherein
said information relating said printer driver with the setting stored in said first storage part is an input information related to at least one of a first icon corresponding to said printer driver and a second icon that is an icon corresponding to the setting stored in said first storage part.
